(19) United States
(12) Patent Application Publication
(10) Pub. No.: US 2012/0062944 A1
(43) Pub. Date: Mar. 15, 2012

(54) IMAGE FORMING APPARATUS, NETWORK SYSTEM, CONTROL METHOD, AND STORAGE MEDIUM

(75) Inventor: Hisashi Nakamoto, Yokohama-shi (JP)

(73) Assignee: CANON KABUSHIKI KAISHA, Tokyo (JP)

(21) Appl. No.: 13/224,684

(22) Filed: Sep. 2, 2011

(30) Foreign Application Priority Data
Sep. 9, 2010 (JP) 2010-201880

(51) Int. Cl. G06K 15/02

(52) U.S. Cl. 358/1.15

(57) ABSTRACT

An image forming apparatus makes a pre-confirmation to a distribution server, and determines whether or not the distribution server has new firmware as compared to the firmware applied to the image forming apparatus based on the result of the pre-confirmation returned from the distribution server. When the distribution server has new firmware as compared to the firmware applied to the image forming apparatus, the image forming apparatus makes an applicable firmware confirmation request to the distribution server, and downloads the firmware that has been returned from the distribution server as a result of applicable firmware confirmation.

### BACKGROUND OF THE INVENTION

1. Field of the Invention

The present invention relates to an image forming apparatus, a network system, a control method, and a storage medium.

2. Description of the Related Art

A monitoring system that remotely monitors the operational state of a peripheral apparatus such as an image forming apparatus and the like has been proposed. Under the monitoring environment provided by the monitoring system, it is contemplated that the firmware of the image forming apparatus be updated as a function of the monitoring system. Here, there is a case where the firmware applied to the image forming apparatus needs to be updated due to the version upgrade of firmware or the occurrence of a failure in the image forming apparatus.

In such a case, conventionally, a service person has had to visit a customer to update firmware manually. Hence, the cost of updating firmware has been high. Accordingly, a system in which a distribution server distributes firmware to an image forming apparatus via the Internet by means of electronic mail or the like has recently been proposed.

Japanese Patent Laid-Open No. 2001-67228 discloses a method in which a printer driver provided in a host PC compares the state of operation firmware for a printer with the firmware requested by a usage application for each print processing to thereby download only the necessary module on the printer. Also, Japanese Patent Laid-Open No. 2002-14919 discloses a communication system in which, when a download request of a music data file is concentrated on a music server from a mobile information terminal, the music server transmits the file to a distribution server and the distribution server transfers the file to the mobile information terminal in a time-dispersed manner.

However, a conventional system for distributing firmware to an image forming apparatus has executed an applicable firmware confirmation regardless of whether or not a distribution server manages new firmware as compared to the firmware applied to the image forming apparatus.

An applicable firmware confirmation is processing for determining optimum firmware to be distributed to an image forming apparatus. In a distribution system including a distribution server, for example, optimum firmware is determined by comparing the firmware applied to an image forming apparatus with the firmware managed by the distribution server with respect to the version and the like of each module included in the firmware. Thus, a large load is exerted on the distribution server for executing an applicable firmware confirmation. Consequently, when applicable firmware confirmation requests are sent to the distribution system from image forming apparatuses around the world using, for example, the functions for the periodic update of the firmware managed by the distribution server, the load on the distribution system undesirably increases beyond the limit.

### SUMMARY OF THE INVENTION

In view of the foregoing, the present invention provides an approach that is capable of reducing the load on a distribution system for distributing firmware.

According to an aspect of the present invention, an image forming apparatus that receives firmware distribution from a distribution system via a network is provided that includes an inquiry unit configured to query the distribution system about whether or not the distribution system manages new firmware as compared to the firmware applied to the image forming apparatus in accordance with a preset schedule; a request unit configured to make a request for distributing the firmware to be applied to the image forming apparatus with respect to the distribution system when a notification indicating that the distribution system manages new firmware is received from the distribution system in response to the inquiry; a download unit configured to download the firmware to be applied from the distribution system when the firmware to be applied to the image forming apparatus is present; an application unit configured to apply the downloaded firmware to the image forming apparatus; and a reception unit configured to receive an instruction including the time when the inquiry is to be made again from the distribution system in response to the request, wherein the inquiry unit makes the inquiry again at the time included in the instruction that has been received by the reception unit.

Further features of the present invention will become apparent from the following description of exemplary embodiments with reference to the attached drawings.

### BRIEF DESCRIPTION OF THE DRAWINGS

FIG. 1 is a diagram illustrating an example of the overall configuration of a network system of the present embodiment.

FIG. 2A is a diagram illustrating an example of the hardware configuration of a monitoring center host.

FIG. 2B is a diagram illustrating an example of the hardware configuration of a monitoring device.

FIG. 2C is another diagram illustrating an example of the hardware configuration of a monitoring device.

FIG. 3 is a diagram illustrating an example of the hardware configuration of an image forming apparatus.

FIG. 4 is a functional block diagram illustrating an example of a monitoring center host.

FIG. 5A is a functional block diagram illustrating an example of a monitoring device.

FIG. 5B is a functional block diagram illustrating an example of an image forming apparatus.

FIG. 5C is a functional block diagram illustrating an example of a communication control unit.

FIG. 6 is a diagram illustrating the structure of a memory map employed in a monitoring center host, a distribution server, a monitoring device, and an image forming apparatus.

FIG. 7A is a diagram illustrating operation processing to be performed in a network system.

FIG. 7B is a diagram illustrating pre-confirmation data.

FIG. 7C is a diagram illustrating applicable firmware confirmation data.

FIG. 7D is a diagram illustrating first firmware information.

FIG. 8A is an exemplary functional block diagram illustrating a distribution server.

FIG. 8B is a diagram illustrating second firmware information.

FIG. 9 is a diagram illustrating an example of an operation processing flow to be performed by an image forming apparatus.

FIG. 10 is a diagram illustrating an example of an operation processing flow to be performed by a distribution server.

FIG. 11 is a flowchart illustrating an example of firmware information comparison processing.

FIG. 12 is a diagram illustrating an operation processing flow to be performed by a distribution server according to another embodiment.

### DESCRIPTION OF THE EMBODIMENTS

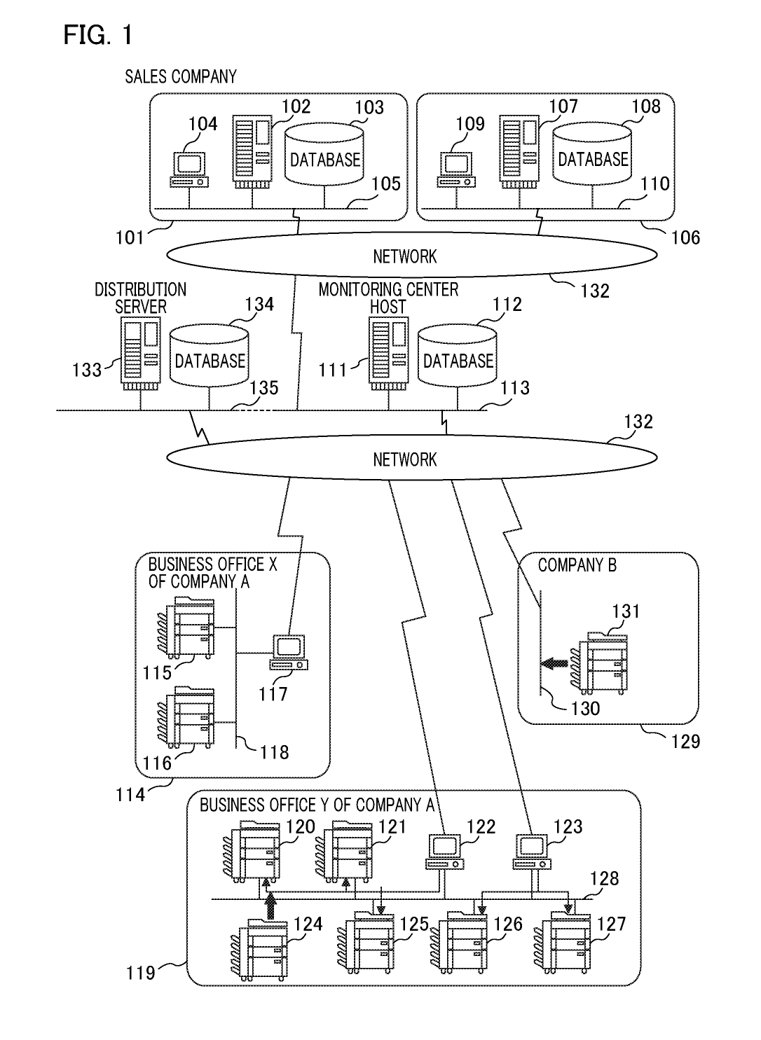

FIG. 1 is a diagram illustrating an example of the overall configuration of a network system of the present embodiment. The network system of the present embodiment is a system that distributes firmware to an image forming apparatus via a network. The control method of the present embodiment is realized by the network system. The network system includes sales company systems (101, 106), customer systems (114, 119, and 129), a distribution server 133, and a monitoring center host 111 that are connected to each other via a network 132. In this example, the network 132 is the Internet.

Each of the sales company systems 101 and 106 is a system of a sales company that sells firmware for the image forming apparatus provided in the customer system. These sales company systems register the settings on information and monitoring regarding the image forming apparatus to be monitored to the monitoring center host 111. The sales company system 101 includes a PC 104, a host computer (hereinafter referred to as “host”) 102, and a database 103. The PC 104, the host 102, and the database 103 are connected to each other via a LAN 106. The sales company system 106 includes a PC 109, a host 107, and a database 108. The PC 109, the host 107, and the database 108 are connected to each other via a LAN 110. The PC 104 and the PC 109, the host 102 and the host 107, and the database 103 and the database 108 respectively have an identical structure. Therefore, a description will be given below by taking the processing units provided in the sales company system 101 as an example.

The PC 104 accumulates sales information about locations and customers managed by a sales company and information about a network system in the database 103 for management. Also, the PC 104 accesses the Web site managed by the monitoring center host 111, and browses information managed by the monitoring center host 111. The host 102 registers information regarding the image forming apparatus to be monitored and the setting for monitoring via a UI (User Interface) provided by the monitoring center host 111. The host 102 may have the same function as that of the PC 104.

The monitoring center host 111 merges the information regarding the image forming apparatus to be monitored and the setting for monitoring, which have been registered by a host computer provided in a sales company system, for comprehensive management. Also, the monitoring center host 111 makes the settings for monitoring in each monitoring device and the image forming apparatus 131. Further, the monitoring center host 111 receives information about the operational status of the image forming apparatus to be monitored from the monitoring devices 117, 122, and 123 provided in the customer system via the network 132. The monitoring center host 111 may directly receive information about the operational status of the image forming apparatus and counter information from the image forming apparatus. The monitoring center host 111 stores and manages information about the operational status of the image forming apparatus and counter information that have been received in a database 112 connected through a LAN 113. That is, the monitoring center host 111 is an information processing device that monitors the state of the image forming apparatus. Then, the monitoring center host 111 provides a Web page for browsing information stored in the database 112 to the PCs 104 and 109 which have gained access to the monitoring center host 111 through the network 132.

Note that the monitoring center host 111 may process information stored in the database 112 so as to provide a Web page for browsing the processed information to a PC. The monitoring center host 111 provides a limited browsing content for each sales company, each customer, and each user authority through the implementation of user authentication. The monitoring center host 111 may change information stored in the database 112 based on information input on the Web page by the PC which has browsed a Web page.

Examples of the operational states of the image forming apparatus include exhausted toner, door-open, drum replacement, no cartridge, cooling fan operation error, error on substrate, stained document mounting glass, no staple, and deficiency in the quantity of light from a paper feeding sensor. Also, examples of the operational states of the image forming apparatus include font memory overflow, rendering error, fixing device error, counter error, two-sided printing unit error, and paper jamming. In addition, examples of counter information include payment counter information, division counter information, size-by-size counter information, and component counter information. Here, the payment counter information indicates information about a counter value for the image forming apparatus used by each customer, which is a target of payment by a sales company. The division counter information indicates information about the amount of payment to be made by each division of the customer. The size-by-size counter information indicates a counter value for each paper size. The component counter information indicates the level of consumption of each component of the image forming apparatus. The payment counter indicates the number of prints printed by the image forming apparatus. The division counter indicates the number of prints with respect to each division, which is set by the customer. With respect to the component counter, the number of rotations is set as the counter for a component such as a drum or the like, while the time (sec) is set as the counter for a component such as a scanner lamp or the like.

The information about the monitoring device to be monitored, the information indicating the operational state of the image forming apparatus, counter information, and the like are stored in the database 112. The monitoring center host 111 may collect information that relates to a failure has occurred in the image forming apparatus from the image forming apparatus to be monitored, and store the information about the failure in the database 112. Also, the monitoring center host 111 may report the information stored in the database 112 to an external apparatus (e.g., the host of a sales company system).

The distribution server 133 is a distribution device that distributes firmware to an image forming apparatus via the network 132. The firmware to be distributed is stored in a database 134. The database 134 is connected to the distribution server 133 via a LAN 135. Note that the database 134 may be physically present in the distribution server 133. Provided that the database 134 is accessible from the distribution server 133, the database 134 may be present at other locations connected to the network 132. The LAN 113 and the LAN 135 may be formed as a single LAN so as to share data with the database 134 and the database 112. In the present embodiment, the distribution server 133 and the database 112 are collectively referred to as a “distribution system”.

In FIG. 1, only one each of the monitoring center host 111, the database 112, the distribution server 133, and the database 134 is illustrated. However, there is also a case in practice that a plurality of monitoring center hosts and databases are used for executing distributed processing in order to perform information collection from many image forming apparatuses and monitoring devices and load sharing for firmware distribution.

Next, a customer-side system will now be described. A network system shown in FIG. 1 includes customer systems 114, 119, and 129. The customer system 114 is a system managed by the business office X of company A. The customer system 119 is a system managed by the business office Y of company A. The customer system 129 is a system managed by company B. In the customer system 114, a monitoring device 117 monitors image forming apparatuses 115 and 116 connected to a LAN 118. In the customer system 119, a monitoring device 122 monitors image forming apparatuses 120, 121, 124, and 125 on a LAN 128. Also, a monitoring device 123 monitors image forming apparatuses 126 and 127 on the LAN 128. Each of the monitoring devices has an identical structure. Each of the monitoring devices receives information indicating the operational state and counter information from the image forming apparatus to be monitored in the customer system in which the monitoring devices are provided, and stores them in database (not shown) for management. Also, the monitoring device transmits information stored in the database to the monitoring center host 111 via the network 132. In the customer system 129, the image forming apparatus 131 itself transmits information indicating the operational state of the image forming apparatus 131 and counter information to the monitoring center host 111 via a LAN 130 and the network 132.

HTTP/SOAP protocol is utilized in the communication via the network 132 in the network system shown in FIG. 1. HTTP is an abbreviation for HyperText Transfer Protocol. SOAP is an abbreviation for Simple Object Access Protocol. The SOAP is a protocol for calling data or service stored in one computer from another computer based on XML (extended Markup Language). In the present embodiment, the SOAP is implemented on HTTP. In the communication by the SOAP, SOAP messages including an XML document to which associated information has been added are exchanged. Accordingly, a computer that supports the SOAP includes a SOAP message generation unit for generating a SOAP message and a SOAP message interpretation unit for interpreting the SOAP message. For example, the SOAP message including information about the operational status of the image forming apparatus described above is transmitted to the monitoring center host 111.

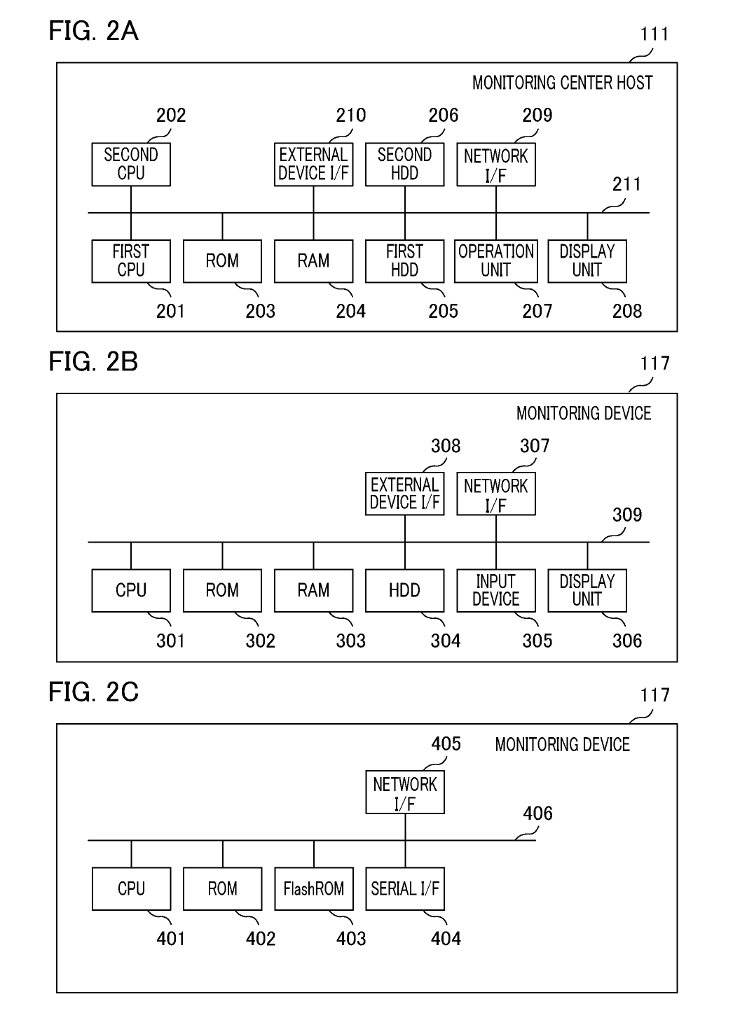

FIGS. 2A to 2C are diagrams illustrating examples of the hardware configuration of a monitoring center host and a monitoring device shown in FIG. 1. FIG. 2A is a diagram illustrating an example of the hardware configuration of the monitoring center host 111. Note that the hardware configuration of the distribution server and the host provided in the network system of the present embodiment is the same as that of the monitoring center host shown in FIG. 2A.

The monitoring center host 111 includes a first CPU 201, a second CPU 202, a ROM 203, a RAM 204, a first HDD 205, a second HDD 206, an operation unit 207, a display unit 208, and a Network I/F 209. The respective processing units are connected to each other via a system bus 211. The first CPU (Central Processing Unit) 201, and the second CPU 202 control the entire monitoring center host 111. The ROM (Read Only Memory) 203 is a non-rewritable storage unit, and stores a program and data related to each process performed by the monitoring center host 111. The RAM (Random Access Memory) 204 stores temporary data related to each process performed by the monitoring center host 111. The first HDD 205 and the second HDD 206 store a program and data related to each process executed by the monitoring center host 111, temporary data, information about the image forming apparatus to be monitored, information collected from the image forming apparatus, and the like.

HDD is an abbreviation for Hard Disk Drive. The first HDD 205 or the second HDD 206 stores, for example, a component counter, a payment counter, a division counter, and the like collected from the image forming apparatus. The operation unit 207 inputs instructions according to a user's operation. The operation unit 207 includes, for example, a keyboard and a pointing device. The display unit 208 displays the operational status of the monitoring center host 111 and information output by each program running on the monitoring center host 111. A Network I/F (Interface) 209 exchanges information with an external apparatus via the network 132. An external device I/F 210 connects an external storage device or the like.

FIG. 2B is a diagram illustrating an example of the hardware configuration of a monitoring device. In FIG. 2B, a description will be given by taking an example of the hardware configuration of the monitoring device 117. The hardware configuration of the monitoring device shown in FIG. 2B is also applicable to the hardware configurations of the PCs 104 and 109. The monitoring device 117 includes a CPU 301, a ROM 302, a RAM 303, an HDD 304, an input device 305, a display unit 306, a Network I/F 307, and an external device I/F 308. The respective processing units are connected to each other via a system bus 309. The CPU 301 controls the monitoring device 117 overall. The ROM 302 stores a program and data related to processing executed by the monitoring device 117. The RAM 303 stores temporary data related to processing executed by the monitoring device 117. The HDD 304 stores a program and data related to processing executed by the monitoring device 117, temporary data, information about the image forming apparatus to be monitored, information collected from the image forming apparatus, and the like. The input device 305 inputs instructions according to a user's operation. The input device 305 includes, for example, a keyboard and a pointing device. The display unit 306 displays operational status information about the monitoring device 117 and information output by each program running on the monitoring device 117. The external device I/F 308 connects an external storage device or the like.

FIG. 2C is a diagram illustrating another example of the hardware configuration of the monitoring device. In the example shown in FIG. 2C, the monitoring device 117 includes a CPU 401, a ROM 402, a Flash ROM 403, a serial I/F 404, and a Network I/F 405. The respective processing units are connected to each other via a system bus 406. The CPU 401 and the ROM 402 have the same functions as those of the CPU 301 and the ROM 302 shown in FIG. 2B, respectively. The Flash ROM 403 stores data and temporary data related to processing executed by the monitoring device 117, information about the image forming apparatus to be monitored, information collected from the image forming apparatus, and the like. The serial I/F 404 mediates processing for outputting error information and log to an external apparatus by the program on the monitoring device 117. The Network I/F 405 exchanges information with an external apparatus via the network 132.

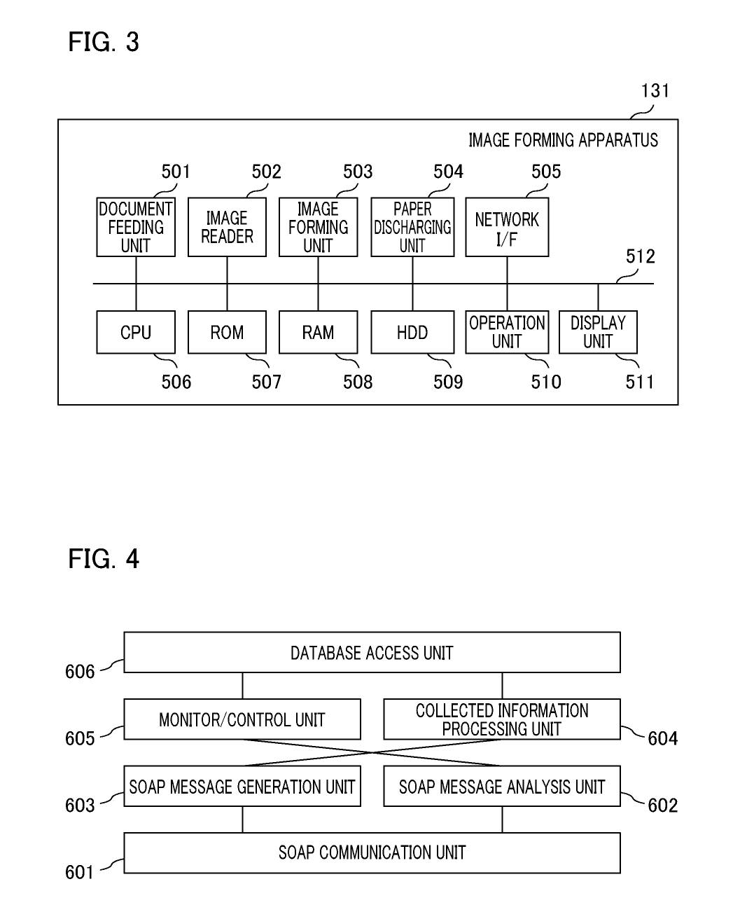

FIG. 3 is a diagram illustrating an example of the hardware configuration of the image forming apparatus shown in FIG. 1. In FIG. 3, a description will be given by taking an example of the hardware configuration of the image forming apparatus 131. Examples of the image forming apparatus include a multifunction peripheral (MFP) integrally providing a printer function and a facsimile function, a printer that receives data from a PC and the like and prints the received data (including an electrophotographic printer and an ink jet printer), a scanner, a facsimile, and the like. In FIG. 3, a description will be given of an exemplary case where the image forming apparatus is a multifunction peripheral. Among the image forming apparatuses shown in FIG. 1, the hardware configuration of the image forming apparatuses other than the image forming apparatus 131 is the same as that of the image forming apparatus 131.

The image forming apparatus 131 includes a document feeding unit 501, an image reader 502, an image forming unit 503, a paper discharging unit 504, a Network I/F 505, a CPU 506, a ROM 507, a RAM 508, an HDD 509, an operation unit 510, and a display unit 511. The respective processing units are connected to each other via a system bus 512. The document feeding unit 501 reads a document in accordance with the instructions given by the image reader 502. The image reader 502 provides instructions about reading a document to the document feeding unit 501. The image forming unit 503 converts the read document and data received via the network 132 into a print image and prints out the image. The paper discharging unit 504 discharges a paper having the printed image thereon and performs sorting processing and stapling processing. The Network I/F 505 exchanges information with an external apparatus via the LAN 130 and the network 132.

The CPU 506 controls the image forming apparatus 131 overall. The CPU 506 monitors the operational status of the image forming apparatus 131. If a specific event such as a failure or the like has occurred, the CPU 506 transmits status information indicating the failure or the like to a predetermined transmission destination. The transmission destination includes the monitoring center host 111, the monitoring device, or the like. The ROM 507 stores a program and data related to processing executed by the image forming apparatus 131. The RAM 508 stores temporary data related to processing executed by the image forming apparatus 131. The HDD 509 stores a program and data related to processing executed by the image forming apparatus 131, temporary data, user data transmitted to the image forming apparatus 131, and the like. Note that a program, by which the image forming apparatus 131 realizes a function of transmitting information indicating the operational state of the image forming apparatus 131 directly to the monitoring center host 111, is stored in the ROM 507 or the HDD 509 in advance. The operation unit 510 inputs instructions according to a user's operation. The display unit 511 displays the operational status of the image forming apparatus 131 and information about a user's operation.

FIG. 4 is a functional block diagram illustrating an example of a monitoring center host. The monitoring center host 111 includes a SOAP communication unit 601, a SOAP message analysis unit 602, a SOAP message generation unit 603, a collected information processing unit 604, a monitor/control unit 605, and a database access unit 606. The SOAP communication unit 601 receives SOAP data from the monitoring device or the image forming apparatus via the Network I/F 209, and then transfers the received SOAP data to the SOAP message analysis unit 602. Also, the SOAP communication unit 601 transmits SOAP data generated by the SOAP message generation unit 603 to the monitoring device or the image forming apparatus via the Network I/F 209. The SOAP message analysis unit 602 analyzes a SOAP message. The SOAP message generation unit 603 generates a SOAP message in accordance with the instructions given by the collected information processing unit 604 and the monitor/control unit 605.

The collected information processing unit 604 acquires information transmitted from the monitoring device, the image forming apparatus 131, or the distribution server 133 based on the analysis result of the SOAP message by the SOAP message analysis unit 602. The collected information processing unit 604 stores the acquired information in the database 112 via the database access unit 606.

Also, the collected information processing unit 604 executes various processes for information stored in the database 112. For example, based on information stored in the database 112, an aggregation of counter information for the image forming apparatus, error information, or the latest information about firmware corresponding to the image forming apparatus is generated, and the generated information is then reported to a service person in charge or a customer-side administrator. For this purpose, the collected information processing unit 604 provides instructions about generating a SOAP message to the SOAP message generation unit 603. The monitor/control unit 605 manages the schedule for acquiring information to the monitoring device or the image forming apparatus, or performs control related to the monitoring settings of the image forming apparatus.

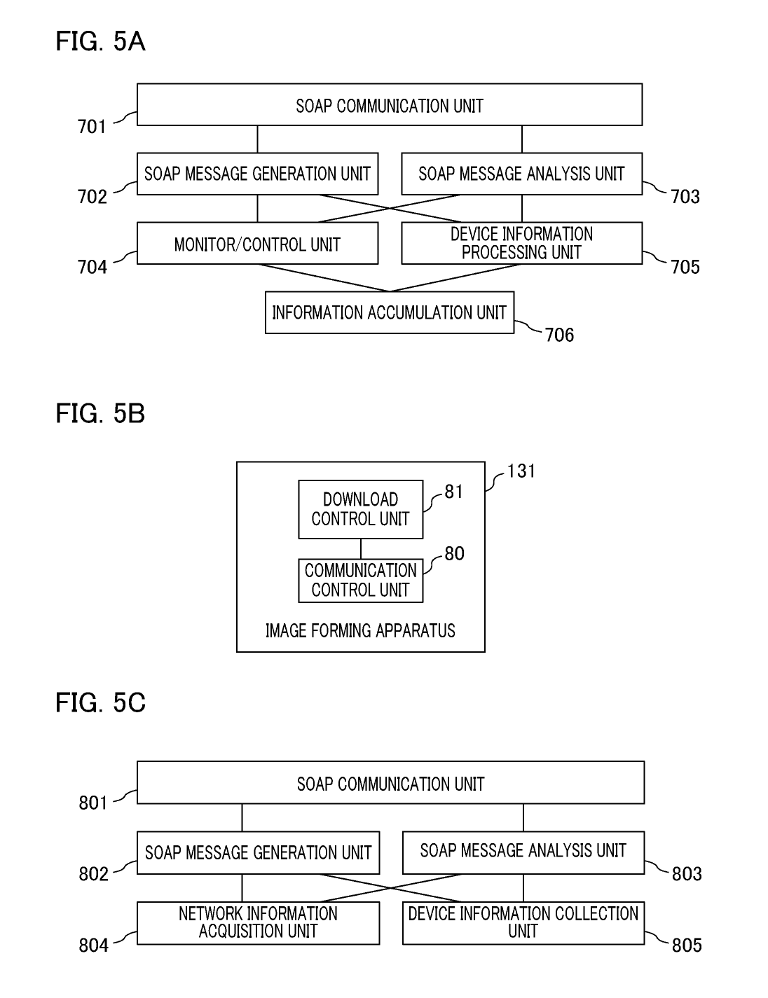

FIGS. 5A to 5C are functional block diagrams illustrating examples of a monitoring device and an image forming apparatus. FIG. 5A is an exemplary functional block diagram illustrating the monitoring device 117. The monitoring device 117 includes a SOAP communication unit 701, a SOAP message generation unit 702, a SOAP message analysis unit 703, a monitor/control unit 704, a device information processing unit 705, and an information accumulation unit 706. The SOAP communication unit 701 receives a SOAP message from the monitoring center host 111 via the network 132, and then transfers the received SOAP message to the SOAP message analysis unit 703. Also, the SOAP communication unit 701 transmits the SOAP message generated by the SOAP message generation unit 702 to the monitoring center host 111 and the distribution server 133. The SOAP message generation unit 702 generates a SOAP message in accordance with the instructions given by the device information processing unit 705 and the monitor/control unit 704. The SOAP message analysis unit 703 analyzes the SOAP message.

The monitor/control unit 704 performs processing corresponding to the monitoring settings of the image forming apparatus by the monitoring center host 111. More specifically, the monitor/control unit 704 stores information about the image forming apparatus to be monitored in the information accumulation unit 706 and updates it. Also, the monitor/control unit 704 stores information acquired from the image forming apparatus to be monitored in the information accumulation unit 706. Furthermore, the monitor/control unit 704 performs processing for transmitting information about the image forming apparatus, which has been stored in the information accumulation unit 706, to the monitoring center host 111. In addition, the monitor/control unit 704 performs processing for transmitting information about the image forming apparatus, which has been stored in the information accumulation unit 706, to the monitoring center host 111. For this purpose, the monitor/control unit 704 provides instructions about generating a SOAP message to the SOAP message generation unit 702.

The device information processing unit 705 acquires information indicating the operational state of the image forming apparatus from the image forming apparatus in accordance with the schedule management performed by the monitor/control unit 704, and stores the acquired information in the information accumulation unit 706. Also, the device information processing unit 705 performs control for transmitting the SOAP message including information stored in the information accumulation unit 706 to the monitoring center host 111 via the SOAP communication unit 701. For this purpose, the device information processing unit 705 provides instructions about generating a SOAP message to the SOAP message generation unit 702.

FIG. 5B is a functional block diagram illustrating an example of an image forming apparatus. In FIG. 5B, a description will be given by taking an example of the functions of the image forming apparatus 131. The image forming apparatus 131 includes a communication control unit 80 and a download control unit 81. The communication control unit 80 controls communication between the image forming apparatus 131 and an external apparatus. The download control unit 81 performs control related to downloading firmware to the image forming apparatus 131. The download control unit 81 functions as an inquiry unit configured to make a pre-confirmation request to the distribution server 133 to thereby query the pre-confirmation result. A pre-confirmation is a process for confirming whether or not the distribution server 133 manages new firmware as compared to the firmware applied to the image forming apparatus 131 of the inquirer. In the present embodiment, a processing load for performing a pre-confirmation is less than that for an applicable firmware confirmation to be described below. In the present embodiment, the download control unit 81 makes a pre-confirmation request in accordance with a preset schedule. For this purpose, the download control unit 81 provides instructions to the communication control unit 80 to cause it to generate a SOAP message including a pre-confirmation request.

The download control unit 81 receives an inquiry result, i.e., a pre-confirmation result, from the distribution server 133 which has performed a pre-confirmation via the communication control unit 80. More specifically, the download control unit 81 receives a notification indicating that new firmware is being managed from the distribution server 133 in response to the inquiry. The download control unit 81 determines whether or not the distribution server 133 has new firmware as compared to the firmware applied to the image forming apparatus 131 based on the received pre-confirmation result. Also, when the download control unit 81 determines that the distribution server 133 has new firmware as compared to the firmware applied to the image forming apparatus 131, the download control unit 81 functions as a request unit configured to perform the following processing. The download control unit 81 makes an applicable firmware confirmation request to the distribution server 133. The applicable firmware confirmation request is a request for executing an applicable firmware confirmation. The applicable firmware confirmation is processing in which the distribution server 133 determines the firmware to be applied to the image forming apparatus 131 and distributes the determined firmware to the image forming apparatus 131.

The download control unit 81 transmits an applicable firmware confirmation request and first firmware information regarding the firmware applied to the image forming apparatus 131 to the distribution server 133. First firmware information is included in an applicable firmware confirmation request. To this end, the download control unit 81 provides instructions to the communication control unit 80, and causes it to generate a SOAP message including an applicable firmware confirmation request. Note that when the download control unit 81 determines that the distribution server 133 does not have new firmware as compared to the firmware applied to the image forming apparatus 131, the distribution server 133 does not make an applicable firmware confirmation request to the distribution server 133. With this arrangement, the distribution server 133 does not receive an applicable firmware confirmation request from the image forming apparatus 131, and thus, the load on the distribution server 133 is reduced.

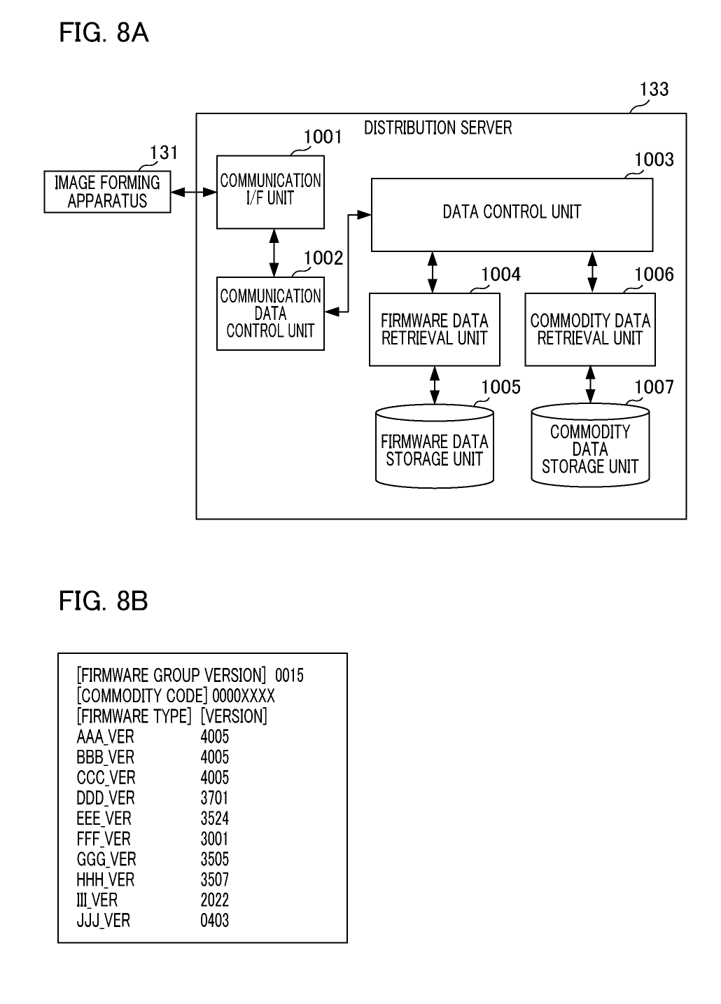

As is described below, the distribution server 133 that has received an applicable firmware confirmation request determines the firmware to be applied to the image forming apparatus 131 based on the comparison result between first firmware information included in the applicable firmware confirmation request and second firmware information. Second firmware information is information, which is stored in a storage unit (the firmware data storage unit 1005 shown in FIG. 8) in advance, regarding the firmware provided in the distribution server 133. The distribution server 133 distributes the determined firmware to the image forming apparatus 131. Then, the download control unit 81 receives the transmission of the firmware URL from the distribution server 133 via the communication control unit 80. The firmware URL is information (location information) indicating the location on a database in which the firmware is stored. Then, the download control unit 81 functions as a download unit configured to download the firmware to be applied to the image forming apparatus 131 from the firmware URL, i.e., the distribution server 133. Note that the download control unit 81 may receive firmware directly from the distribution server 133 so as to download the received firmware to the image forming apparatus 131. The download control unit 81 also functions as an application unit configured to apply the downloaded firmware to the image forming apparatus 131. A storage medium for causing a computer to execute a method for controlling an image forming apparatus is realized by the functions of the processing units provided in the image forming apparatus 131 shown in FIG. 5B.

FIG. 5C is an exemplary functional block diagram illustrating the communication control unit 80 shown in FIG. 5B. FIG. 5C shows the processing units that realize the functions related to communication with SOAP among the processing units provided in the communication control unit 80. The communication control unit 80 includes a SOAP communication unit 801, a SOAP message generation unit 802, a SOAP message analysis unit 803, a network information acquisition unit 804, and a device information collection unit 805. The SOAP communication unit 801 receives a SOAP message from the monitoring center host 111 and the distribution server 133 via the network 302. The SOAP communication unit 801 transfers the received SOAP message to the SOAP message analysis unit 803. Also, the SOAP communication unit 801 transmits the SOAP message generated by the SOAP message generation unit 802 to the monitoring center host 111 and the distribution server 133. The SOAP message generation unit 802 generates a SOAP message in accordance with the instructions given by the network information acquisition unit 804, the device information collection unit 805, or the download control unit 81 shown in FIG. 5B. For example, the SOAP message generation unit 802 generates a SOAP message including a pre-confirmation request or a SOAP message including an applicable firmware confirmation request. The SOAP message analysis unit 803 analyzes a SOAP message, and transfers the analysis result to the network information acquisition unit 804, a device information acquisition unit 806, or the download control unit 81 shown in FIG. 5B.

The network information acquisition unit 804 automatically acquires an IP (Internet Protocol) address, a DNS server, and a gateway address in the DHCP environment. DHCP is an abbreviation for Dynamic Host Configuration Protocol. DNS is an abbreviation for Domain Name Server. The network information acquisition unit 804 may acquire network information stored in the HDD 509 (see FIG. 3). The device information collection unit 805 acquires information indicating the operational state of the image forming apparatus 131 and counter information in accordance with the schedule followed inside the image forming apparatus 131 or the instructions given by the monitoring center host 111. The device information collection unit 805 provides instructions to the SOAP message generation unit 802 about generating a SOAP message including the acquired these information.

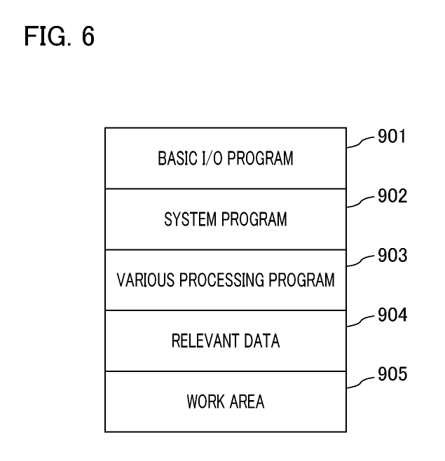

FIG. 6 is a diagram illustrating the structure of a memory map employed in a monitoring center host, a distribution server, a monitoring device, and an image forming apparatus. The monitoring center host 111 and the distribution server 133 load a program related to the present embodiment to the RAM 204 (see FIG. 2A), and then execute the loaded program. The respective monitoring devices load a program related to the present embodiment to the RAM 303 (see FIG. 2B) or the Flash ROM 403 (see FIG. 2C), and then execute the loaded program. Also, the respective image forming apparatuses load a program related to the present embodiment to the RAM 508 (see FIG. 3), and then execute the loaded program. The memory map shown in FIG. 6 is a memory map in the state where the monitoring center host, the distribution server, the monitoring device, and the image forming apparatus have loaded a program to the RAM or the Flash ROM described above. The memory map shown in FIG. 6 is constituted by a basic I/O (Input Output) program 901, a system program 902, a various processing program 903, an area 904 for storing relevant data, and a work area 905 for a program.

The basic I/O program 901 controls an input and an output to and from the image forming apparatus. The system program 902 provides an operation environment for various processing programs. The various processing programs are programs that execute the processing of the present embodiment. When an area for use as the basic I/O program 901 through the work area 905 is insufficient because of the constraints of the capacity, the first HDD 205 or the second HDD 206 shown in FIG. 2A may also be considered as a portion of the area of the RAM 204. Also, the HDD 304 shown in FIG. 2B may also be considered as a portion of the area of the RAM 303. Likewise, the HDD 509 shown in FIG. 3 may also be considered as a portion of the area of the RAM 508.

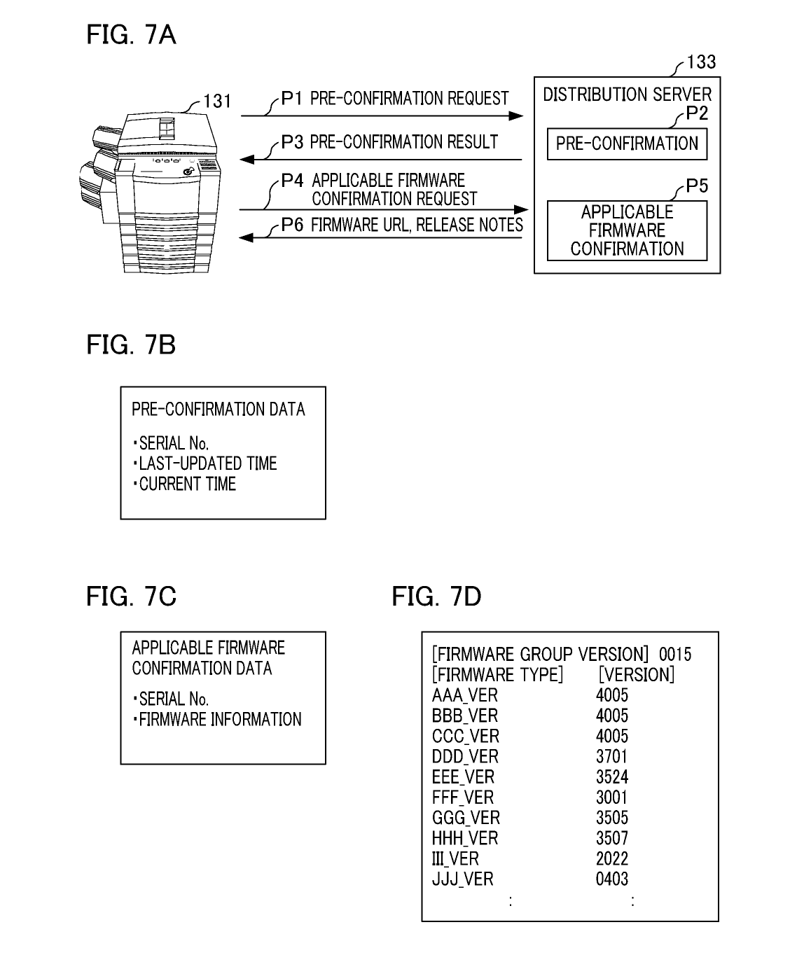

Each of FIGS. 7A to 7D is a diagram illustrating operation processing to be performed in a network system of the present embodiment.

FIG. 7A is a diagram illustrating an operation processing sequence between the image forming apparatus 131 and the distribution server 133 provided in the distribution system. Firstly, the image forming apparatus 131 makes a pre-confirmation request to the distribution server 133 (P1 in FIG. 7A). The image forming apparatus 131 transmits a pre-confirmation request and pre-confirmation data that is used by the distribution server 133 for executing a pre-confirmation to the distribution server 133. A pre-confirmation request includes pre-confirmation data.

FIG. 7B shows an example of pre-confirmation data. Pre-confirmation data includes a serial number, a last-updated time, and a current time. The serial number is identification information for uniquely identifying the image forming apparatus 131. The last-updated time is the last-updated time of the firmware applied to the image forming apparatus 131. The current time is the present time.

Referring back to FIG. 7A, the distribution server 133 provides a pre-confirmation based on pre-confirmation data (P2 in FIG. 7A). The details of the pre-confirmation will be described below with reference to FIGS. 8A and 8B. The distribution server 133 returns information indicating whether or not the distribution server 133 has new firmware as compared to the firmware applied to the image forming apparatus 131 as the pre-confirmation result to the image forming apparatus 131 (P3 in FIG. 7A). The image forming apparatus 131 determines whether or not the distribution server 133 has new firmware as compared to the firmware applied to the image forming apparatus 131 based on the pre-confirmation result returned from the distribution server 133. When the image forming apparatus 131 determines that the distribution server 133 does not have new firmware as compared to the firmware applied to the image forming apparatus 131, the process is ended.

When the image forming apparatus 131 determines that the distribution server 133 has new firmware as compared to the firmware applied to the image forming apparatus 131, the image forming apparatus 131 makes an applicable firmware confirmation request to the distribution server 133 (P4 in FIG. 7A). The applicable firmware confirmation request includes applicable firmware confirmation data to be used for the execution of the applicable firmware confirmation by the distribution server 133.

FIG. 7C shows an example of applicable firmware confirmation data. Applicable firmware confirmation data includes the serial number of an image forming apparatus and firmware information (first firmware information) about firmware applied to the image forming apparatus 131.

FIG. 7D shows an example of first firmware information. First firmware information has data configurations including a firmware group version and a firmware type. The firmware group version is the version of the entire firmware corresponding to first firmware information. The firmware type is the type of each module included in the firmware. A version is associated with each firmware type. Correspondence information between a firmware type and a version included in first firmware information is the configuration information of the firmware corresponding to first firmware information. Hereinafter, correspondence information is referred to as “firmware configuration information”.

Referring back to FIG. 7A, the distribution server 133 that has received an applicable firmware confirmation request executes an applicable firmware confirmation (P5 in FIG. 7A). More specifically, the distribution server 133 determines the firmware to be applied to the image forming apparatus 131 using applicable firmware confirmation data received from the image forming apparatus 131. Then, the distribution server 133 transmits the firmware URL, release notes, and the like as information to be used for downloading the determined firmware to the image forming apparatus 131 (P6 in FIG. 7A). The image forming apparatus 131 downloads the firmware from the received firmware URL for installation. The details of the applicable firmware confirmation will be described below.

Each of FIGS. 8A and 8B is a diagram illustrating exemplary functions of a distribution server. FIG. 8A shows an exemplary functional block diagram of the distribution server 133. The distribution server 133 includes a communication I/F unit 1001, a communication data control unit 1002, a data control unit 1003, a firmware data retrieval unit 1004, a firmware data storage unit 1005, a commodity data retrieval unit 1006, and a commodity data storage unit 1007.

The communication I/F unit 1001 mediates communication between the distribution server 133 and an apparatus external to the distribution server 133 (for example, the image forming apparatus 131). The communication data control unit 1002 controls communication between the distribution server 133 and external apparatuses. For example, the communication data control unit 1002 receives a pre-confirmation request and an applicable firmware confirmation request from the image forming apparatus 131 via the communication I/F unit 1001, and passes them to the data control unit 1003. As a result of the pre-confirmation, the communication data control unit 1002 receives the pre-confirmation result and information to be used for downloading the firmware to be applied to the image forming apparatus 131 from the data control unit 1003, and transmits them to the image forming apparatus 131 via the communication I/F unit 1001.

The data control unit 1003 functions as a response unit configured to receive the pre-confirmation request passed from the communication data control unit 1002 and to execute the pre-confirmation in response to the pre-confirmation request. In other words, the data control unit 1003 determines whether or not the distribution server 133 manages new firmware as compared to the firmware applied to the image forming apparatus 131. More specifically, the data control unit 1003 provides instructions to the commodity data retrieval unit 1006 to cause it to search the commodity data storage unit 1007. With this arrangement, the data control unit 1003 acquires the commodity code, which is associated with the serial number of the image forming apparatus included in the pre-confirmation request, from the commodity data storage unit 1007. The commodity code is a code that is uniquely set for each commodity of the image forming apparatus 131.

The data control unit 1003 provides instructions to the firmware data retrieval unit 1004 to cause it to search the firmware data storage unit 1005. The firmware data retrieval unit 1004 searches second firmware information associated with the acquired commodity code, and searches the registration time of the firmware that corresponds to second firmware information obtained by the retrieval. The data control unit 1003 acquires the registration time(s) of one or a plurality of firmware associated with the commodity code. The registration time is the time upon which the firmware managed by the distribution server 133 is registered to the distribution server 133. The data control unit 1003 compares the last-updated time included in the pre-confirmation request with each of the acquired registration times, and determines whether or not the distribution server 133 has new firmware as compared to the firmware applied to the image forming apparatus 131 based on the comparison result. With this arrangement, the distribution server 133 may execute the pre-confirmation with a smaller load than that on the execution of the applicable firmware confirmation to be described below.

When a registration time after the last-updated time is present, the data control unit 1003 determines that the distribution server 133 has new firmware as compared to the firmware applied to the image forming apparatus 131. When a registration time after the last-updated time is absent, the data control unit 1003 determines that the distribution server 133 does not have new firmware as compared to the firmware applied to the image forming apparatus 131. Then, the data control unit 1003 responds to the image forming apparatus 131 by setting the determination result as the pre-confirmation result (inquiry result). In other words, the data control unit 1003 provides a notification indicating that new firmware is managed in response to the inquiry from the image forming apparatus 131.

Also, the data control unit 1003 receives the applicable firmware confirmation request passed from the communication data control unit 1002, and executes the applicable firmware confirmation in response to the applicable firmware confirmation request. In other words, the data control unit 1003 determines the firmware to be applied to the image forming apparatus 131 and distributes it to the image forming apparatus 131.

The data control unit 1003 determines the firmware to be applied to the image forming apparatus 131 in the following manner. The data control unit 1003 compares first firmware information included in the applicable firmware confirmation request with second firmware information stored in the firmware data storage unit 1005. Second firmware information is information regarding the firmware provided in the distribution server 133, i.e., firmware registered in the distribution server 133.

FIG. 8B shows an example of second firmware information. Second firmware information has a structure in which the commodity code is added to first firmware information shown in FIG. 7D. The firmware group version is the version of the entire firmware corresponding to second firmware information. The firmware type is the type of each module included in the firmware. Each version is associated with each firmware type. Correspondence information between a firmware type and a version included in second firmware information is firmware configuration information corresponding to second firmware information.

The data control unit 1003 determines the firmware to be applied to the image forming apparatus 131 based on the comparison result between first firmware information and second firmware information. More specifically, the data control unit 1003 provides instructions to the commodity data retrieval unit 1006 to cause it to search the commodity data storage unit 1007. With this arrangement, the data control unit 1003 acquires the commodity code, which is associated with the serial number of the image forming apparatus included in the applicable firmware confirmation request, from the commodity data storage unit 1007. Subsequently, the data control unit 1003 provides instructions to the firmware data retrieval unit 1004 to cause it to search the firmware data storage unit 1005. The firmware data retrieval unit 1004 searches a firmware group version included in second firmware information associated with the acquired commodity code. Among the firmware group versions obtained by the retrieval, the data control unit 1003 acquires a new firmware group version as compared to the firmware group version included in first firmware information.

The data control unit 1003 determines second firmware information including a new firmware group version as compared to the firmware group version included in first firmware information. Then, the data control unit 1003 compares firmware configuration information included in the determined second firmware information with firmware configuration information included in first firmware information, and determines the firmware to be applied to the image forming apparatus 131 based on the comparison result. With this arrangement, the data control unit 1003 may quickly determine the firmware to be applied to the image forming apparatus compared to when information included in first firmware information is compared with all information included in second firmware information. More specifically, the data control unit 1003 compares a version of a firmware type included in first firmware information with a version of a firmware type included in second firmware information for each same firmware type. When a new version as compared to any version of the firmware types included in first firmware information is present in the versions of the firmware types included in second firmware information, the data control unit 1003 performs the following processing. The data control unit 1003 determines the firmware corresponding to this second firmware information as the firmware to be applied to the image forming apparatus 131.

In the present embodiment, the data control unit 1003 receives an applicable firmware confirmation request, and then determines whether or not the load on the distribution server 133 is equal to or greater than a predetermined threshold value before the aforementioned applicable firmware confirmation is executed. More specifically, the data control unit 1003 determines whether or not the utilization rate of the CPU provided in the distribution server 133 is equal to or greater than a predetermined threshold value. The data control unit 1003 may determine whether or not the number of communication sessions between the distribution server 133 and the external apparatus is equal to or greater than a predetermined threshold value.

When the load on the distribution server 133 is equal to or greater than a predetermined threshold value, the data control unit 1003 makes a delay request that includes a reschedule time to the image forming apparatus 131. The delay request is a request for making a pre-confirmation request again to the image forming apparatus 131 after the elapse of the reschedule time. In other words, the reschedule time is the time at which a pre-confirmation request is made again. The data control unit 1003 calculates a time taken for the load of the distribution server 133 to be reduced (a time taken for the load thereof to reach a predetermined value or less) as the reschedule time, and specifies the calculated reschedule time in the delay request. When the load on the distribution server 133 is less than a predetermined threshold value, the data control unit 1003 executes the aforementioned applicable firmware confirmation.

The firmware data retrieval unit 1004 searches the firmware data storage unit 1005 in accordance with an instruction given from the data control unit 1003. The commodity data retrieval unit 1006 searches the commodity data storage unit 1007 in accordance with an instruction given from the data control unit 1003. The firmware data storage unit 1005 stores second firmware information and a registration time, at which the firmware corresponding to second firmware information is registered in the distribution server 133, in advance. The commodity data storage unit 1007 stores a commodity code associated with the serial number of the image forming apparatus in advance.

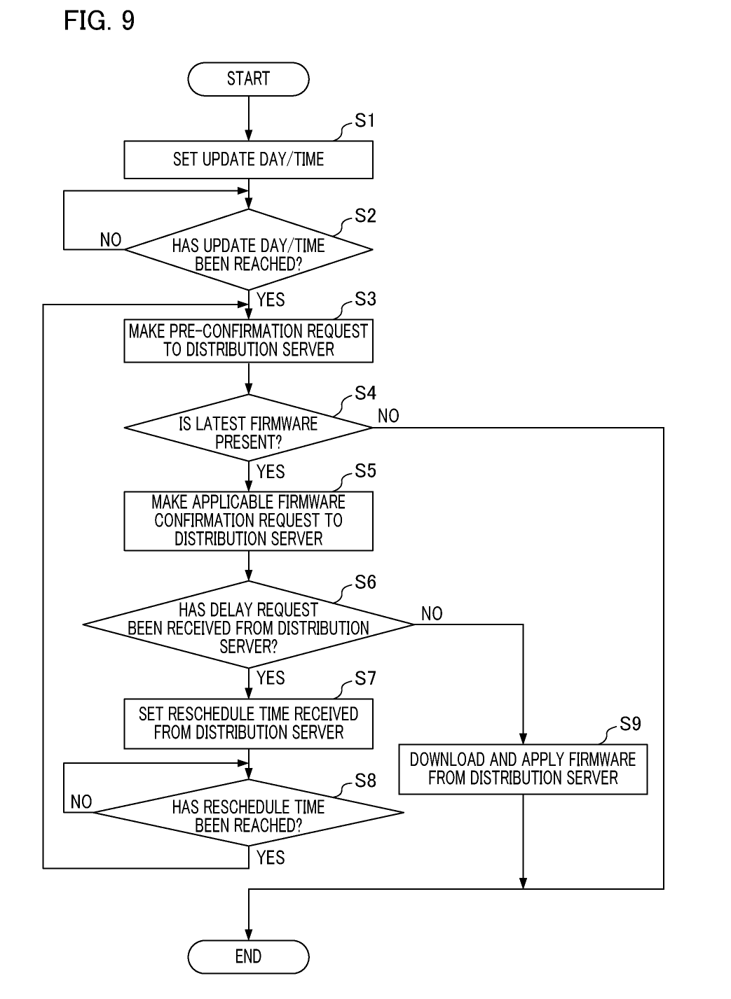

FIG. 9 is a diagram illustrating an example of an operation processing flow to be performed by an image forming apparatus. Firstly, the download control unit 81 of the image forming apparatus 131 sets the update day/time as the schedule settings for a periodic update based on a user's operation input using the operation unit 510 (step S1). In step S1, the download control unit 81 may set the update day/time in accordance with an instruction given from the monitoring center host 111.

Next, the download control unit 81 determines whether or not the update day/time has been reached (step S2). When the update day/time has not been reached, the process returns to step S2. When the update day/time has been reached, the download control unit 81 makes a pre-confirmation request to the distribution server 133 (step S3), and receives the pre-confirmation result from the distribution server 133 that has performed the pre-confirmation. Subsequently, the download control unit 81 determines whether or not the distribution server 133 has new firmware (hereinafter referred to as “the latest firmware”) as compared to the firmware applied to the image forming apparatus 131 based on the received pre-confirmation result (step S4).

When the distribution server 133 does not have the latest firmware, the process is ended. When the distribution server 133 has the latest firmware, the download control unit 81 makes an applicable firmware confirmation request to the distribution server 133 (step S5). Subsequently, the download control unit 81 determines whether or not a delay request has been received from the distribution server 133 via a reception unit, i.e., the communication control unit 80, in response to the applicable firmware confirmation request (step S6). When the delay request has not been received from the distribution server 133, the download control unit 81 downloads the firmware to be applied to the image forming apparatus 131 from the firmware URL that has been returned from the distribution server 133 and applies it to the image forming apparatus 131 (step S9).

When the delay request has been received from the distribution server 133, the download control unit 81 sets the reschedule time that has been specified in the delay request (step S7). Subsequently, the download control unit 81 determines whether or not the set reschedule time has been reached (step S8). When the set reschedule time has not been reached, the process returns to step S8. When the set reschedule time has been reached, the process returns to step S3, and the download control unit 81 makes a pre-confirmation request again. With this arrangement, the distribution server 133 may receive a request (a pre-confirmation request, an applicable firmware confirmation request) from the image forming apparatus 131 when the load on the image forming apparatus 131 is reduced after the elapse of the reschedule time.

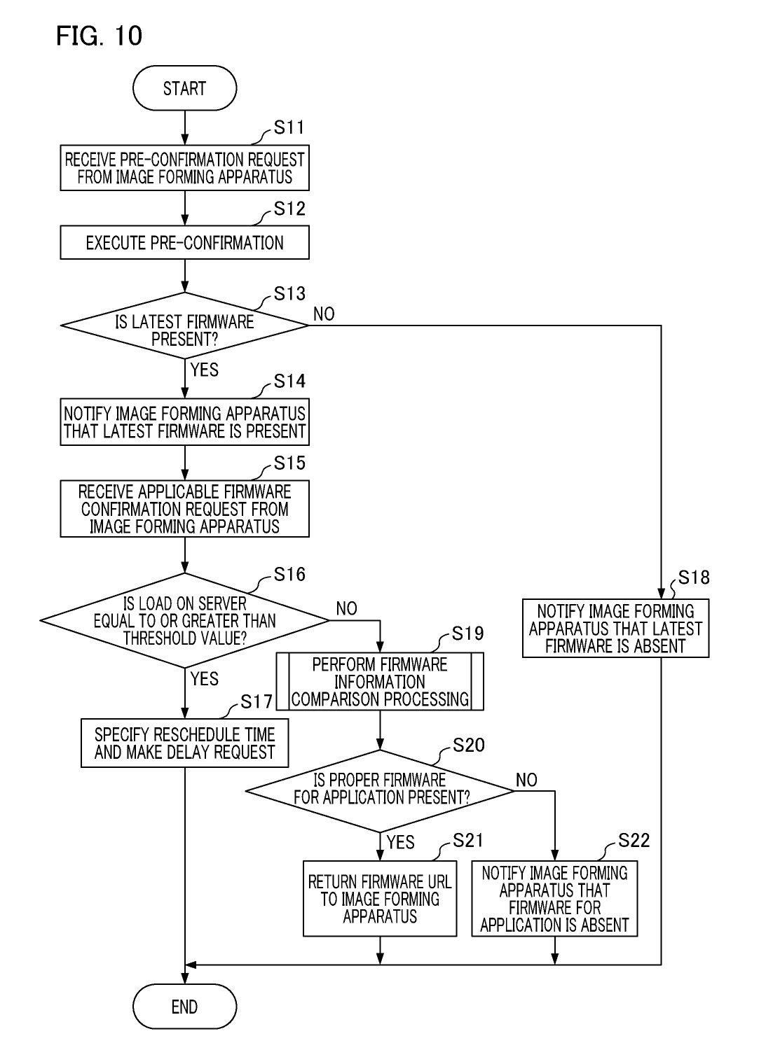

FIG. 10 is a diagram illustrating an example of an operation processing flow to be performed by a distribution server. Firstly, the data control unit 1003 of the distribution server 133 receives a pre-confirmation request from the image forming apparatus 131 via the communication I/F unit 1001 and the communication data control unit 1002 (step S11). Next, the data control unit 1003 executes the pre-confirmation (step S12). The data control unit 1003 determines whether or not the distribution server 133 has the latest firmware (step S13). When the distribution server 133 does not have the latest firmware, the data control unit 1003 notifies the image forming apparatus 131 that the distribution server 133 does not have the latest firmware (step S18). When the distribution server 133 has the latest firmware, the data control unit 1003 notifies the image forming apparatus 131 that the distribution server 133 has the latest firmware (step S14).

Next, the data control unit 1003 receives an applicable firmware confirmation request from the image forming apparatus 131 via the communication I/F unit 1001 and the communication data control unit 1002 (step S15). Subsequently, the data control unit 1003 determines whether or not the load on the distribution server 133 is equal to or greater than a threshold value (step S16). Here, the load on the distribution server 133 is the communication load on the distribution server 133 mainly from an external apparatus such as the image forming apparatus 131, and the data control unit 1003 determines whether or not the load is aberrantly high. When the load on the distribution server 133 is equal to or greater than a threshold value, the data control unit 1003 specifies the reschedule time and makes a delay request to the image forming apparatus 131 (step S17).

When the load on the distribution server 133 is less than a threshold value, the data control unit 1003 executes an applicable firmware confirmation to be described below. In other words, the data control unit 1003 performs firmware information comparison processing (step S19). More specifically, the data control unit 1003 compares first firmware information included in the applicable firmware confirmation request with second firmware information in the firmware data storage unit 1005, and determines the firmware to be applied the image forming apparatus 131 based on the comparison result. Hereinafter, the firmware to be applied the image forming apparatus 131 is referred to as “firmware for application”.

Next, the data control unit 1003 determines whether or not proper firmware for application is present (step S20). When the data control unit 1003 determines that proper firmware for application is absent, the data control unit 1003 notifies the image forming apparatus 131 that the distribution server 133 does not have firmware for application (step S22). When the data control unit 1003 determines that proper firmware for application is present, the data control unit 1003 performs the following processing in order to download the firmware for application to the image forming apparatus 131. The data control unit 1003 returns the firmware URL corresponding to the proper firmware for application to the image forming apparatus 131 (step S21). As described above, the firmware URL is specifically information indicating the location on the database in which the firmware is stored, and the image forming apparatus 131 downloads the firmware for application based on this information.

The image forming apparatus of the present embodiment requests an execution of a pre-confirmation on which the processing load is lower than that on an applicable firmware confirmation before making an applicable firmware confirmation request to the distribution server 133. Only when the image forming apparatus 131 determines that the distribution server 133 has the latest firmware based on the pre-confirmation result does the image forming apparatus 131 make an applicable firmware confirmation request to the distribution server 133. Thus, according to the image forming apparatus of the present embodiment, the load on a distribution server that distributes firmware to the image forming apparatus may be reduced.

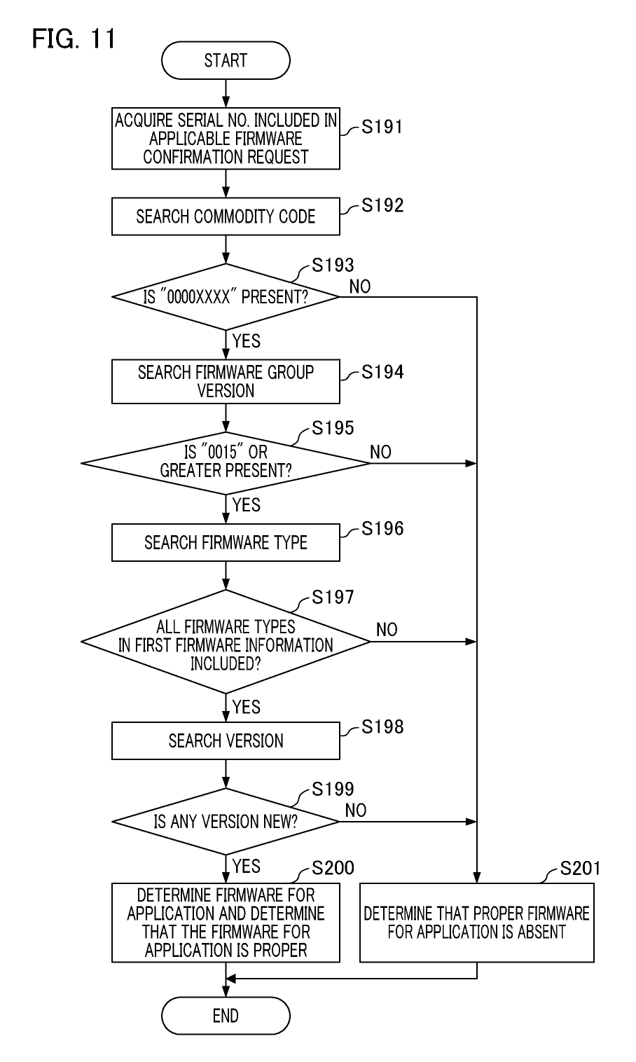

FIG. 11 is a flowchart illustrating an example of firmware information comparison processing in step S19 shown in FIG. 10. In this example, the applicable firmware confirmation request received by the data control unit 1003 in step S15 shown in FIG. 10 is intended to include first firmware information shown in FIG. 7D.

Firstly, the data control unit 1003 acquires the serial number of an image forming apparatus included in an applicable firmware confirmation request (step S191). Subsequently, the data control unit 1003 searches and acquires a commodity code associated with the serial number acquired in step 5191 from the commodity data storage unit 1007 (step S192). In this example, the acquired commodity code is “0000XXXX”.

Next, the data control unit 1003 determines whether or not second firmware information corresponding to the acquired commodity code “0000XXXX” is present in second firmware information in the firmware data storage unit 1005 (step S193). When second firmware information corresponding to the commodity code “0000XXXX” is absent, the data control unit 1003 determines that proper firmware for application is absent (step S201), and the process is ended.

When second firmware information corresponding to the commodity code “0000XXXX” is present, the data control unit 1003 searches the firmware group versions included in second firmware information (step S194). The data control unit 1003 determines whether or not a new firmware group version as compared to the firmware group version included in first firmware information is present in the firmware group versions obtained by the retrieval in step 5194. The firmware group version included in first firmware information shown in FIG. 7D is “0015”. Thus, the data control unit 1003 determines whether or not the firmware group version equal to or greater than “0015” is present in the firmware group versions obtained by the retrieval in step 5194 (step S195). When the firmware group version equal to or greater than “0015” is absent, the process advances to step 5201.

When the firmware group version equal to or greater than “0015” is present, the data control unit 1003 searches the firmware types in second firmware information including the firmware group versions equal to or greater than “0015” (step S196). In other words, the data control unit 1003 determines whether or not the firmware types in second firmware information include all of the firmware types in first firmware information (step S197). When a firmware type in first firmware information, which is not included in any firmware type in second firmware information, is present, the process advances to step 5201. When the firmware types in second firmware information include all of the firmware types in first firmware information, the data control unit 1003 performs the following processing. The data control unit 1003 searches the versions of the firmware types in second firmware information (step S198). A version of a firmware type in second firmware information is compared with a version of a firmware type in first firmware information for each same firmware type. The data control unit 1003 determines whether or not a new version as compared to any version of the firmware types in first firmware information is present in the versions of the firmware types in second firmware information (step S199). When a new version as compared to any version of the firmware types in first firmware information is absent in the versions of the firmware types in second firmware information, the process advances to step 5201.

When a new version as compared to any version of the firmware types in first firmware information is present in the versions of the firmware types in second firmware information, the data control unit 1003 performs the following processing. The data control unit 1003 determines the firmware corresponding to second firmware information as firmware for application, and determines that the determined firmware for application is proper (step S200).

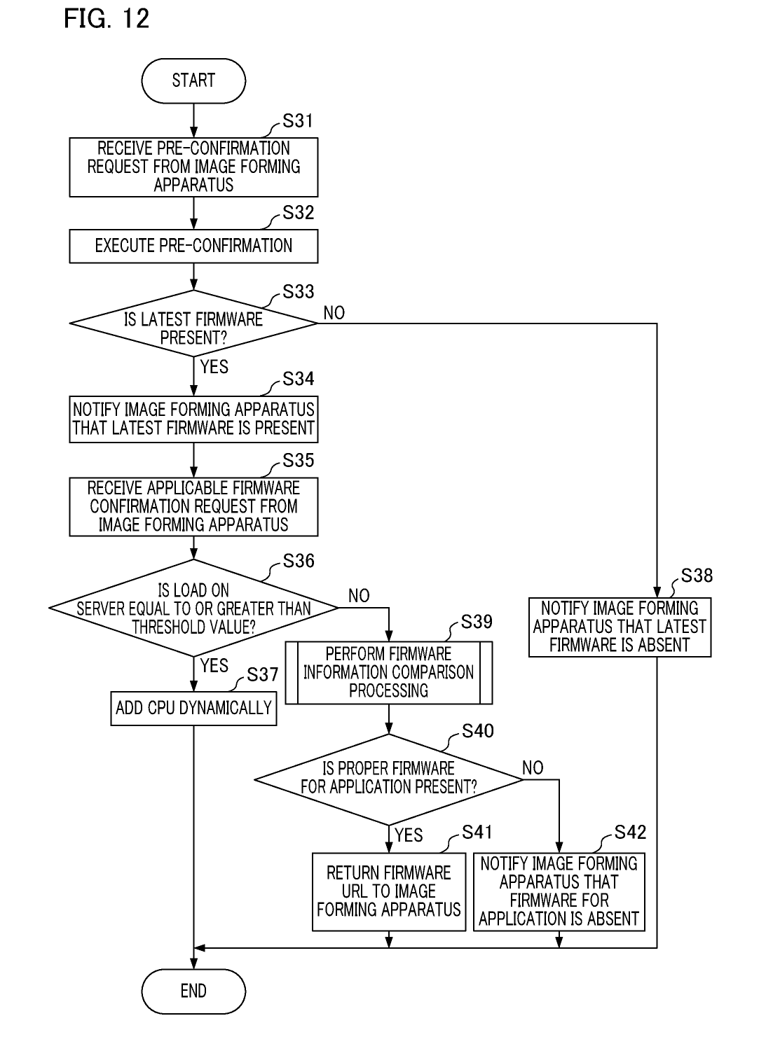

FIG. 12 is a diagram illustrating an operation processing flow to be performed by a distribution server according to another embodiment. Steps S31 to S36 shown in FIG. 12 are the same as steps S11 to S16 shown in FIG. 10. Also, step S38 to S42 shown in FIG. 12 are the same as steps S18 to S22 shown in FIG. 10. In the example shown in FIG. 12, the distribution server 133 has a function of dynamically adding a CPU, i.e., a control unit configured to control a distribution device, using a known CPU virtualization technique.

When the data control unit 1003 determines that the load on the distribution server 133 is equal to or greater than a threshold value (step S36), the process transits to step S37. In step S37, the distribution server 133 dynamically adds a CPU that is allocated for external communication. In step S37, the distribution server 133 may also increase the upper limit of the number of communication sessions between the distribution server 133 and the external apparatus. Then, the distribution server 133 transmits instructions for making a pre-confirmation request to the image forming apparatus 131 again. The image forming apparatus 131 provides a pre-confirmation upon receipt of the instructions. Here, instead of transmitting instructions for making a pre-confirmation request to the image forming apparatus 131, instructions for making an applicable firmware confirmation request may be transmitted to the image forming apparatus 131. According to the distribution server 133 of another embodiment described with reference to FIG. 12, the load on the distribution server 133 may be reduced when the upper limit of the load on the distribution server 133 is reached.

According to the distribution system of the embodiments of the present invention described above, the load on the distribution system may be reduced when a number of image forming apparatuses make a firmware distribution request to the distribution system.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-201880 filed Sep. 9, 2010, which is hereby incorporated by reference herein in its entirety.

What is claimed is:

1. An image forming apparatus that receives firmware distribution from a distribution system via a network, the image forming apparatus comprising:
an inquiry unit configured to query the distribution system about whether or not the distribution system manages new firmware as compared to the firmware applied to the image forming apparatus in accordance with a preset schedule;
a request unit configured to make a request for distributing the firmware to be applied to the image forming apparatus with respect to the distribution system when a notification indicating that the distribution system manages new firmware is received from the distribution system in response to the inquiry;
a download unit configured to download the firmware to be applied from the distribution system when the firmware to be applied to the image forming apparatus is present;
an application unit configured to apply the downloaded firmware to the image forming apparatus; and
a reception unit configured to receive an instruction including a time when the inquiry is to be made again from the distribution system in response to the request,
wherein the inquiry unit makes the inquiry again at the time included in the instruction that has been received by the reception unit.

2. The image forming apparatus according to claim 1, wherein an inquiry made by the inquiry unit includes identification information about an image forming apparatus and a last-updated time of the firmware applied to the image forming apparatus.

3. The image forming apparatus according to claim 2, wherein the distribution system determines whether or not the distribution system manages new firmware as compared to the firmware applied to the image forming apparatus based on the comparison result obtained when the last-updated time included in the inquiry is compared to the registration time of the firmware managed by the distribution system, and further provides a notification indicating that the distribution system manages new firmware in response to the inquiry to the image forming apparatus based on the determination result.

4. The image forming apparatus according to claim 1, wherein a request made by the request unit includes information about the version of the firmware applied to the image forming apparatus.

5. A method for controlling an image forming apparatus that receives firmware distribution from a distribution system via a network, the method comprising the steps of:
inquiring, in an inquiry step, the distribution system about whether or not the distribution system manages new firmware as compared to the firmware applied to the image forming apparatus in accordance with a preset schedule;
making, in a request step, a request for distributing the firmware to be applied to the image forming apparatus with respect to the distribution system when a notification indicating that the distribution system manages new firmware is received from the distribution system in response to the inquiry;
downloading, in a download step, the firmware to be applied from the distribution system when the firmware to be applied to the image forming apparatus is present;
applying, in an application step, the downloaded firmware to the image forming apparatus; and
receiving, in a reception step, an instruction including a time when the inquiry is to be made again from the distribution system in response to the request,
wherein the inquiry step makes the inquiry again at the time included in the instruction that has been received in the reception step.

6. A computer-readable storage medium on which is stored a computer program for making a computer execute a method for controlling an image forming apparatus that receives firmware distribution from a distribution system via a network, the method comprising the steps of:
inquiring, in an inquiry step, the distribution system about whether or not the distribution system manages new firmware as compared to the firmware applied to the image forming apparatus in accordance with a preset schedule;
making, in a request step, a request for distributing the firmware to be applied to the image forming apparatus with respect to the distribution system when a notification indicating that the distribution system manages new firmware is received from the distribution system in response to the inquiry;
downloading, in a download step, the firmware to be applied from the distribution system when the firmware to be applied to the image forming apparatus is present;
applying, in an application step, the downloaded firmware to the image forming apparatus; and
receiving, in a reception step, an instruction including a time when the inquiry is to be made again from the distribution system in response to the request,
wherein the inquiry step makes the inquiry again at the time included in the instruction that has been received in the reception step.

7. A network system comprising an image forming apparatus and a distribution system that distributes firmware to the image forming apparatus via a network,
wherein the image forming apparatus comprises:
an inquiry unit configured to query the distribution system about whether or not the distribution system manages new firmware as compared to the firmware applied to the image forming apparatus in accordance with a preset schedule;
a request unit configured to make a request for distributing the firmware to be applied to the image forming apparatus with respect to the distribution system when a notification indicating that the distribution system manages new firmware is received from the distribution system in response to the inquiry;
a download unit configured to download the firmware to be applied from the distribution system when the firmware to be applied to the image forming apparatus is present;
an application unit configured to apply the downloaded firmware to the image forming apparatus; and
a reception unit configured to receive an instruction including a time when the inquiry is to be made again from the distribution system in response to the request, and
wherein the distribution system comprises:
a response unit configured to provide a notification indicating that the distribution system manages new firmware to the image forming apparatus in response to the inquiry from the image forming apparatus when the distribution system manages new firmware as compared to the firmware applied to the image forming apparatus;
a unit configured to return location information at which the firmware to be applied to the image forming apparatus is stored to the image forming apparatus so as to cause the image forming apparatus to download the firmware in response to the request from the image forming apparatus when the firmware to be applied to the image forming apparatus is present; and
a transmission unit configured to transmit an instruction including a time at which the image forming apparatus should make the inquiry again when a request is received from the image forming apparatus and a communication load on the distribution system is equal to or greater than a threshold value,
wherein the inquiry unit provided in the image forming apparatus makes the inquiry again at the time included in the instruction that has been received by the reception unit.

8. The network system according to claim 7, wherein the distribution system determines whether or not the distribution system manages new firmware as compared to the firmware applied to the image forming apparatus based on the comparison result obtained when the last-updated time, which is included in the inquiry, of the firmware applied to the image forming apparatus is compared to the registration time of the firmware managed by the distribution system, and the response unit provides a notification indicating that the distribution system manages new firmware in response to the inquiry based on the determination result.

9. The network system according to claim 7, wherein a request made by the request unit includes information about the version of the firmware applied to the image forming apparatus.

10. The network system according to claim 7, wherein the distribution system determines the firmware to be applied to the image forming apparatus from new firmware managed by the distribution system based on information, which is included in the request, about the version of the firmware to be applied to the image forming apparatus.

11. A method for controlling a network system comprising an image forming apparatus and a distribution system that distributes firmware to the image forming apparatus via a network, the method comprising the steps of:
inquiring, in an inquiry step to be performed by the image forming apparatus, the distribution system about whether or not the distribution system manages new firmware as compared to the firmware applied to the image forming apparatus in accordance with a preset schedule;
providing, in a response step to be performed by the distribution system, a notification indicating that the distribution system manages new firmware to the image forming apparatus in response to the inquiry from the image forming apparatus when the distribution system manages new firmware as compared to the firmware applied to the image forming apparatus;
making, in a request step to be performed by the image forming apparatus, a request for distributing the firmware to be applied to the image forming apparatus with respect to the distribution system when a notification indicating that the distribution system manages new firmware is received from the distribution system in response to the inquiry;
returning, in a return step to be performed by the distribution system, location information at which the firmware to be applied to the image forming apparatus is stored to the image forming apparatus so as to cause the image forming apparatus to download the firmware in response to the request from the image forming apparatus when the firmware to be applied to the image forming apparatus is present;
downloading, in a download step to be performed by the image forming apparatus to which the location information has been returned, the firmware to be applied from the distribution system; and
applying, in an application step to be performed by the image forming apparatus, the downloaded firmware to the image forming apparatus;
wherein the distribution system transmits an instruction including a time at which the image forming apparatus should make the inquiry again when a request is received from the image forming apparatus and a communication load on the distribution system is equal to or greater than a threshold value, the image forming apparatus receives an instruction including the time when the inquiry is to be made again from the distribution system in response to the request, and the image forming apparatus makes the inquiry again at the time included in the instruction that has been received in the reception step.
